(19) United States
(12) Patent Application Publication
(10) Pub. No.: US 2025/0218286 A1
(43) Pub. Date: Jul. 3, 2025

(54) TRIP TIME MEASUREMENT DEVICE, TRAFFIC INFORMATION PROVISION SERVER, TRIP TIME MEASUREMENT METHOD, AND PROGRAM RECORDING MEDIUM

(71) Applicant: NEC Corporation, Minato-ku, Tokyo (JP)

(72) Inventors: Yasuhiko OCHIAI, Tokyo (JP); Keisuke INOUE, Tokyo (JP); Motoharu OHTAKE, Tokyo (JP)

(73) Assignee: NEC Corporation, Minato-ku, Tokyo (JP)

(21) Appl. No.: 18/852,657

(22) PCT Filed: Apr. 11, 2022
(86) PCT No.: PCT/JP2022/017516

§ 371 Date: Sep. 30, 2024

(51) Int. Cl. G08G 1/01; G06V 20/58

(52) U.S. Cl. CPC G08G 1/0125; G06V 20/58

(57) ABSTRACT

A measurement device according to an aspect of the present disclosure includes: at least one memory configured to store instructions: and at least one processor configured to execute the instructions to: detect vehicles traveling on a road from an image of the road captured by a camera; identify attributes of the detected vehicles and applying labels relevant to the attributes; measure a first trip time required for a vehicle having a first label, from among the identified vehicles, to travel a predetermined segment of the road; measure a second trip time required for a vehicle having a second label, from among the identified vehicles, to travel the predetermined segment; and output each of the first trip time and the second trip time.

### TECHNICAL FIELD

The present invention relates to a trip time measurement device, a traffic information provision server, a trip time measurement method, and a program recording medium.

### BACKGROUND ART

In the Ministry of Land, Infrastructure, Transport and Tourism, a trip time survey is conducted targeting on major roads in a national road and street traffic situation survey approximately every five years. In the next national road and street traffic situation survey, the Ministry of Land, Infrastructure, Transport and Tourism has announced a policy of calculating a trip speed using data obtained from in-vehicle devices of ETC (Electronic Toll Collection System) 2.0.

PTL 1 discloses a trip time calculation system for calculating an average trip time between two points of a road network using a smart plate or a wireless communication terminal device attached to a vehicle.

### CITATION LIST

### Patent Literature

PTL 1: JP 2006-221237 A

### Non Patent Literature

NPL 1: Ministry of Land, Infrastructure, Transport and Tourism, “Method for calculating trip speed in next national road and street traffic situation survey”, [online], [Searched on Mar. 18, 2022], Internet <https://www.mlit.go.jp/road/ir/ir-council/ict/pdf04/03.pdf>

### SUMMARY OF INVENTION

### Technical Problem

In the above-described trip time survey of the Ministry of Land, Infrastructure, Transport and Tourism, no trip time survey for each size and type of vehicles has been conducted. In this regard, PTL 1 also only describes that trip time is measured except for route buses, emergency vehicles, and the like that are different in traveling form from general vehicles (see paragraph 0096).

An object of the present invention is to provide a trip time measurement device, a traffic information provision server, a trip time measurement method, and a program recording medium capable of measuring trip time for each vehicle having an attribute of interest such as size and type among vehicles traveling on a road.

### Solution to Problem

According to a first aspect, there is provided a trip time measurement device including: a detection means for detecting vehicles traveling on a road from an image of the road captured by a camera; an identification means for identifying attributes of the detected vehicles and applying labels relevant to the attributes; a first trip time measurement means for measuring a first trip time required for a vehicle having a first label, from among the identified vehicles, to travel a predetermined segment of the road; a second trip time measurement means for measuring a second trip time required for a vehicle having a second label, from among the identified vehicles, to travel the predetermined segment; and an output means for outputting each of the first trip time and the second trip time.

According to a second aspect, there is provided a traffic information provision server for receiving the first trip time and the second trip time from the trip time measurement device described above, and providing the first trip time and the second trip time to a user terminal as traffic information.

According to a third aspect, there is provided a traffic information provision server for receiving the first trip time and the second trip time, and provides the same to a user terminal as traffic information, the traffic information provision server receiving the first trip time and the second trip time from the trip time measurement device described above, performing route calculation using at least one of the first trip time and the second trip time in response to a request from a user terminal; and providing the user terminal as route information.

According to a fourth aspect, there is provided a trip time measurement method including: detecting vehicles traveling on a road from an image of the road captured by a camera; identifying attributes of the detected vehicles and applying labels relevant to the attributes; measuring a first trip time required for a vehicle having a first label, from among the identified vehicles, to travel a predetermined segment of the road; measuring a second trip time required for a vehicle having a second label, from among the identified vehicles, to travel the predetermined segment; and outputting each of the first trip time and the second trip time.

According to a fifth aspect, there is provided a program for causing a computer to execute processes of: detecting vehicles traveling on a road from an image of the road captured by a camera; identifying attributes of the detected vehicles and applying labels relevant to the attributes; measuring a first trip time required for a vehicle having a first label, from among the identified vehicles, to travel a predetermined segment of the road; measuring a second trip time required for a vehicle having a second label, from among the identified vehicles, to travel the predetermined segment; and outputting each of the first trip time and the second trip time.

### Advantageous Effects of Invention

According to the present invention, there are provided a trip time measurement device, a traffic information provision server, a trip time measurement method, and a program recording medium capable of measuring trip time for each vehicle having an attribute of interest such as size and type among vehicles traveling on a road.

### BRIEF DESCRIPTION OF DRAWINGS

FIG. 1 is a diagram illustrating a configuration according to one example embodiment of the present invention.

FIG. 2 is a diagram illustrating a configuration of the first example embodiment of the present invention.

FIG. 3 is a functional block diagram illustrating a configuration of a trip time measurement device according to the first example embodiment of the present invention.

FIG. 4 is a diagram for explaining the operation of the trip time measurement device according to the first example embodiment of the present invention.

FIG. 5 is a diagram illustrating an example of a measurement result of a trip time by the trip time measurement device according to the first example embodiment of the present invention.

FIG. 6 is a diagram illustrating an example of a time distance diagram created by the trip time measurement device according to the first example embodiment of the present invention.

FIG. 7 is a flowchart illustrating an operation of the trip time measurement device according to the first example embodiment of the present invention.

FIG. 8 is another diagram for describing the operation of the trip time measurement device according to the first example embodiment of the present invention.

FIG. 9 is another diagram illustrating an example of a measurement result of a trip time by the trip time measurement device according to the first example embodiment of the present invention.

FIG. 10 is a diagram illustrating another example of a time distance diagram created by the trip time measurement device according to the first example embodiment of the present invention.

FIG. 11 is a diagram illustrating another example of a time distance diagram created by the trip time measurement device according to the first example embodiment of the present invention.

FIG. 12 is another diagram for describing the operation of the trip time measurement device according to the first example embodiment of the present invention.

FIG. 13 is another diagram for describing the operation of the trip time measurement device according to the first example embodiment of the present invention.

FIG. 14 is a diagram illustrating a configuration of a second example embodiment of the present invention.

FIG. 15 is a flowchart illustrating an operation of one example embodiment of the present invention.

FIG. 16 is a diagram illustrating a configuration of a computer that can function as a trip time measurement device and a traffic information provision server of the present invention.

### EXAMPLE EMBODIMENT

First, an outline of one example embodiment of the present invention will be described with reference to the drawings. The reference numerals in the drawings attached to this outline are attached to each element for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with a device (including a computer) inside or outside the device via a communication interface regardless of whether wired or wireless. Although there are ports and interfaces at connection points of input and output of each block in the drawing, the illustration thereof will be omitted.

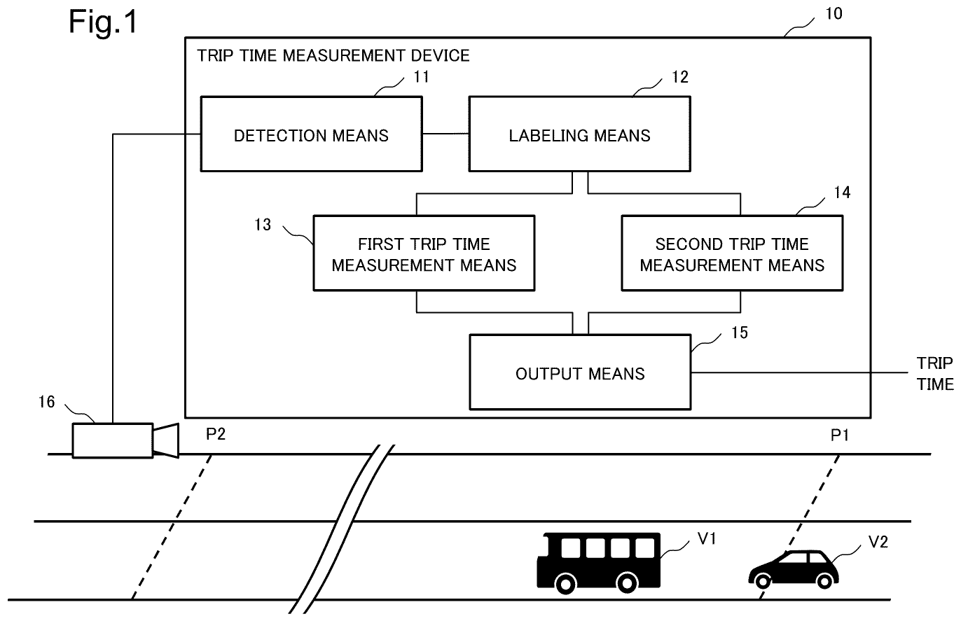

In one example embodiment of the present invention, as illustrated in FIG. 1, the present invention can be achieved by a trip time measurement device 10 including a detection means 11, a labeling means 12, a first trip time measurement means 13, a second trip time measurement means 14, and an output means 15.

More specifically, the detection means 11 detects a vehicle (reference signs V1 and V2 in FIG. 1) traveling on the road from an image of the road captured by a camera 16. The camera 16 is installed, for example, at a position where a vehicle traveling on the road can be captured.

The labeling means 12 identifies an attribute of the detected vehicle and applies a label according to the attribute. For example, when it is determined to apply a first label to a passenger vehicle and a second label to a large vehicle, the labeling means 12 applies the second label to the vehicle VI and applies the second label to the vehicle V2. As the attribute to which the label is applied, various attributes that can indicate trip time, such as a category of a vehicle, a vehicle model, an application, a color or a symbol of a license plate, and whether the vehicle is a special vehicle, can be considered.

The first trip time measurement means 13 measures a first trip time required for a vehicle having a first label among the identified vehicles to travel a predetermined segment of the road, for example, from point Pl to point P2 in FIG. 1. The second trip time measurement means 14 measures a second trip time required for a vehicle having a second label among the identified vehicles to travel the predetermined segment P1 to P2.

The output means 15 outputs each of the first trip time and the second trip time.

One or more cameras 16 are installed at positions where vehicles passing through a predetermined segment can be photographed. For example, as the camera 16, in addition to a traffic flow monitoring camera installed near an intersection or a road, various security cameras can be used.

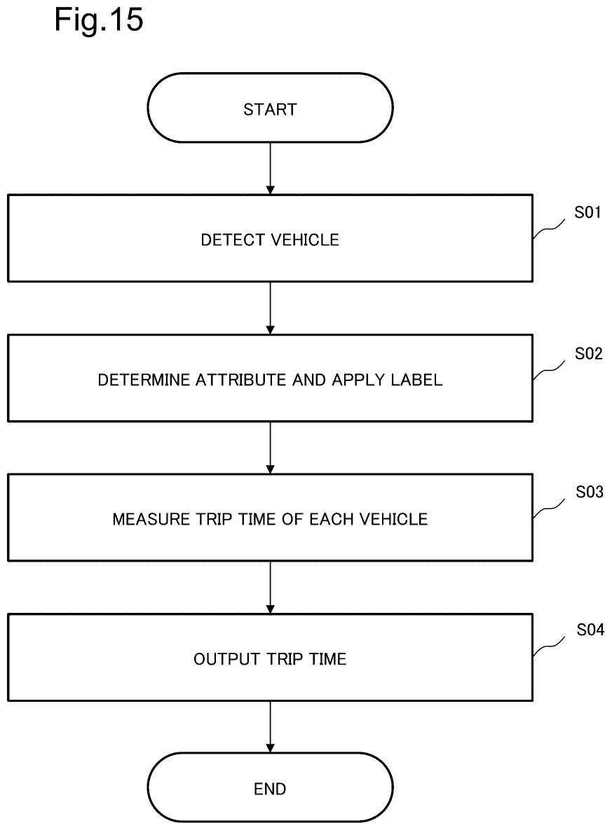

In the trip time measurement device 10 operating as described above, as illustrated in FIG. 15, the trip time measurement device 10 first detects a vehicle (reference signs V1 and V2 in FIG. 1) traveling on a road (step S01). Next, the trip time measurement device 10 identifies each attribute of the detected vehicle and applies a label (step S02). Next, the trip time measurement device 10 measures trip time of each vehicle (step S03). Finally, the trip time measurement device 10 outputs the measured trip time to a predetermined output destination (step S04).

According to the present example embodiment, it is possible to measure the trip time of when vehicles having different attributes travel through the same segment. For example, it is possible to evaluate the magnitude of the influence of the difference in size of the vehicle body of the passenger vehicle and the large vehicle on the trip time by assigning a first label to the passenger vehicle, assigning a second label to the large vehicle, and comparing the trip times. For example, when the trip time of a large vehicle is extremely longer than the trip time of a passenger vehicle, it is conceivable that there is an obstacle or the like hindering passage of the large vehicle in the corresponding road section. In that case, it is possible to take measures such as repairing the road and prohibiting entry of large vehicles.

### First Example Embodiment

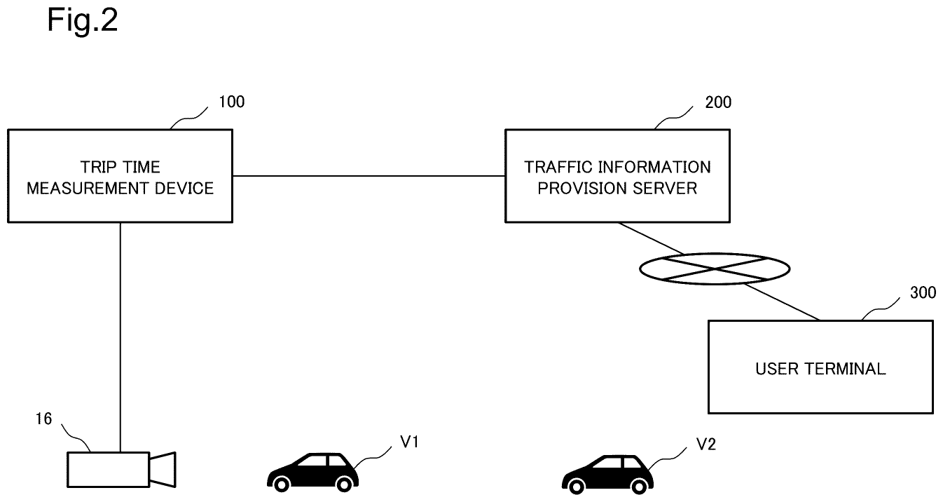

Next, a first example embodiment of the present invention in which trip time measured by a trip time measurement device is provided to a user terminal will be described in detail with reference to the drawings. FIG. 2 is a diagram illustrating a configuration of the first example embodiment of the present invention. Referring to FIG. 2, there is illustrated a configuration in which a trip time measurement device 100 capable of acquiring an image from a camera 16 and a traffic information provision server 200 that provides data to a user terminal 300 are connected.

One or more cameras 16 are installed at positions where vehicles passing through a predetermined segment can be photographed. Although one camera 16 is illustrated in the example of FIG. 2, a plurality of cameras 16 may be installed. For example, one or more cameras 16 may be installed at each of a start point and an end point of the predetermined segment, and the images may be transmitted to the trip time measurement device 100.

The trip time measurement device 100 is a device for measuring a trip time of a traveling vehicle from an image of a road captured by the camera 16 and providing the travel time to the traffic information provision server 200.

The traffic information provision server 200 receives data including the trip time provided from the trip time measurement device 100 and provides the data to the user terminal 300 as traffic information. As the user terminal 300, a terminal of a road management department of a national or local public organization is assumed, but this is not the sole case. For example, the user terminal 300 may be a terminal of a road user such as a physical distribution trader or a general user.

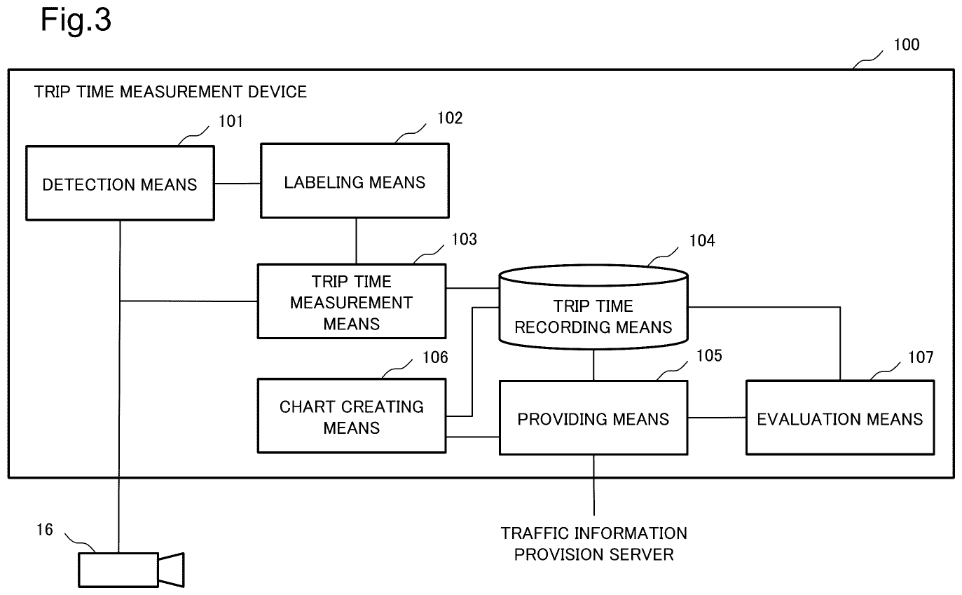

FIG. 3 is a functional block diagram illustrating a configuration of a trip time measurement device 100 according to the first example embodiment of the present invention. Referring to FIG. 3, a trip time measurement device 100 including a detection means 101, a labeling means 102, a trip time measurement means 103, a trip time recording means 104, a providing means 105, a chart creating means 106, and an evaluation means 107 is illustrated.

The detection means 101 detects a vehicle traveling on the road from the image of the road captured by the camera 16. The labeling means 102 identifies an attribute of the detected vehicle and applies a For the detection of the vehicle and the identification of the label. attribute, for example, it is possible to use a method of detecting a region in which the recognition target will appear from the feature amount or the like of the image and identifying the recognition target using a classification model or the like created in advance by machine learning or the like.

The trip time measurement means 103 tracks the vehicle to which the label is applied by the labeling means 102, measures the trip time required for the vehicle to travel through a predetermined segment, and records the result in the trip time recording means 104. Therefore, the trip time measurement means 103 functions as the first and second trip time measurement means. The predetermined segment can be a segment set between the first position and the second position in the captured image of the camera 16. Furthermore, in a case where there is a plurality of cameras 16, a segment set between the first position in the captured image of the first camera and the second position in the captured image of the second camera can be set as the predetermined segment.

The above-described tracking of the vehicle can be performed by determining whether the vehicles detected at different places and times are the same. For example, it is possible to adopt a method of extracting features of the vehicle detected at the first position, and extracting features of the vehicle detected at the second position, and determining that the vehicles are the same when these features match. Furthermore, for example, in a case where the first position and the second position are set in the photographing range of the same camera, it is possible to adopt a method of tracking the vehicle between frames based on the position, size, and the like of the vehicle in the image of each frame continuously captured by the camera.

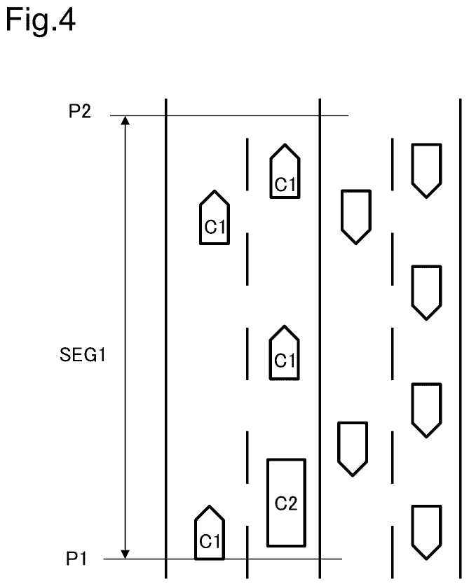

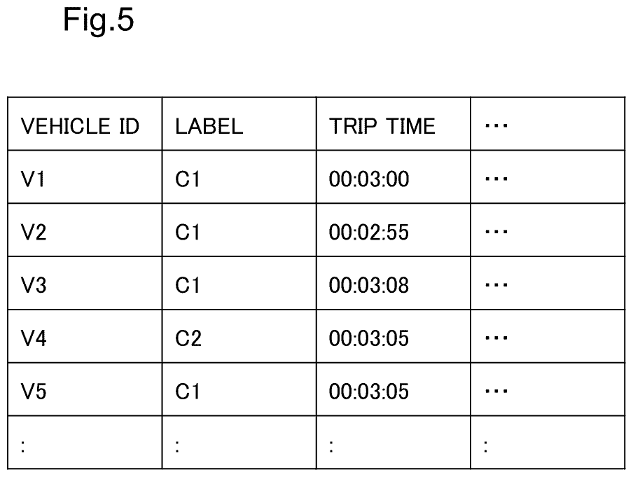

Here, operations of the detection means 101, the labeling means 102, and the trip time measurement means 103 will be described with reference to FIGS. 4 and 5. In the following description, description will be made assuming that a label C2 is applied to an emergency vehicle and a label C1 is applied to other vehicles. For example, the detection means 101 detects vehicles traveling in two lanes on the left side of the road illustrated in FIG. 4, and applies V1 to V5 as vehicle IDs to the vehicles. Then, the labeling means 102 identifies the attributes of the vehicles V1 to V5 and applies the labels C1 and C2 (see FIG. 4).

The trip time measurement means 103 tracks the moving object to which the label is applied, and measures the trip time in a predetermined segment SEG1 from point P1 to point P2. FIG. 5 illustrates a table in which trip times of five vehicles V1 to V5 recorded in the trip time recording means 104 are recorded. The average trip time of the vehicle group with the label C1 is 3 minutes 2 seconds, and the trip time of the emergency vehicle with the label C2 is 3 minutes 5 seconds.

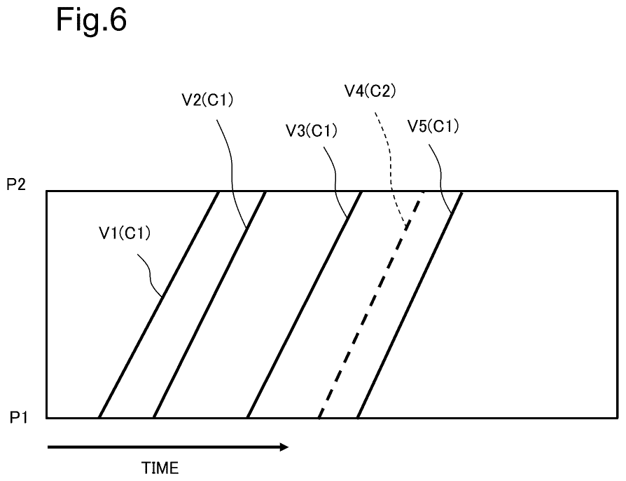

The chart creating means 106 uses the information recorded in the trip time recording means 104 to create a time distance diagram (also referred to as a time space diagram) representing the movement situation of the vehicle from the first position to the second position in time series. FIG. 6 is a diagram illustrating an example of a time distance diagram created by the chart creating means 106. In FIG. 6, the vertical axis represents the distance from point P1 to point P2, and the horizontal axis represents time. In the example of FIG. 6, the time distance lines of the vehicles V1 to V5 are drawn substantially parallel. It can also be seen from this time distance diagram that there is no large difference in trip time between the vehicle group with the label C1 and the vehicle with the label C2. Therefore, it can be evaluated that the emergency vehicle can travel from point P1 to point P2 at substantially the same speed as the other vehicles.

The evaluation means 107 uses the information recorded in the trip time recording means 104 to evaluate the situation of the road where the trip time is measured. For example, the evaluation means 107 compares the first trip time of the vehicle group with the label C1 and the second trip time of the vehicle group with the label C2 to generate the evaluation on the appropriateness of the width of the road. In addition, for example, as will be described later, the evaluation means 107 generates an evaluation as to whether the road is suitable for traveling by the emergency vehicle based on the trip time of the emergency vehicle and the trip times of other vehicles.

The providing means 105 provides the traffic information provision server 200 with the data and the time distance diagram recorded in the trip time recording means 104. Therefore, the providing means 105 corresponds to the above-described output means.

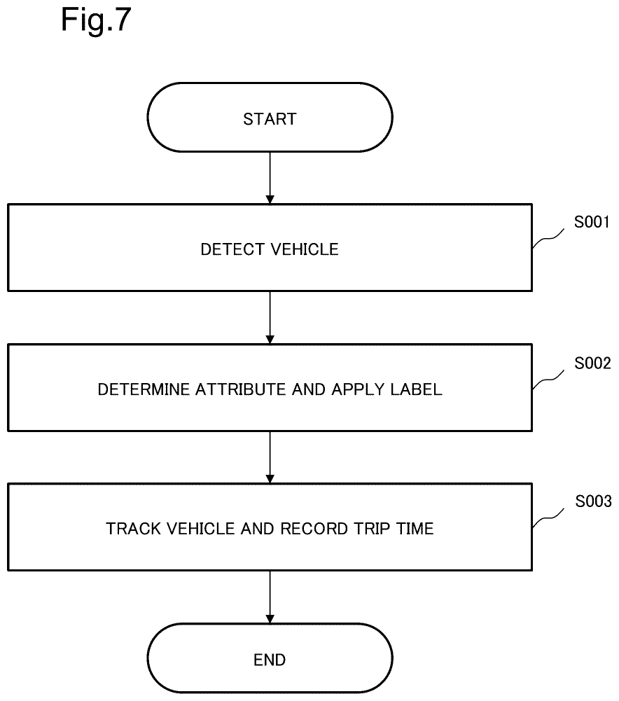

Next, a trip time measurement method used in the trip time measurement device 100 according to the present example embodiment will be described in detail with reference to the drawings. FIG. 7 is a flowchart illustrating operation of the trip time measurement device 100 according to the first example embodiment of the present invention. Referring to FIG. 7, first, the trip time measurement device 100 detects a vehicle from an image captured by the camera 16 (step S001).

Next, the trip time measurement device 100 determines an attribute of the detected vehicle and applies a label (step S002).

Next, the trip time measurement device 100 tracks the vehicle to which the label is applied, measures the trip time thereof, and records the trip time in the trip time recording means 104 (step S003).

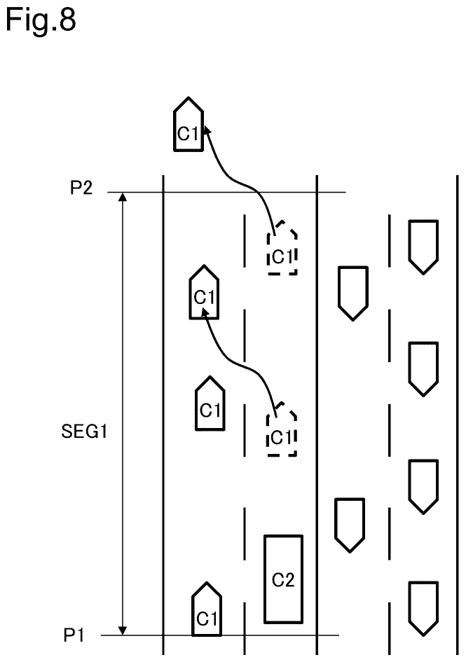

FIG. 8 is another diagram for describing the operation of the trip time measurement device according to the first example embodiment of the present invention. FIG. 8 is a diagram illustrating the movement of the vehicle when the emergency vehicle C2 sounds a siren and travels in an emergency. In this case, as indicated by an arrow in the figure, the vehicle C1 traveling in the overtaking lane needs to move to the left lane and stop in such a way as not to hinder the traveling by the emergency vehicle C2.

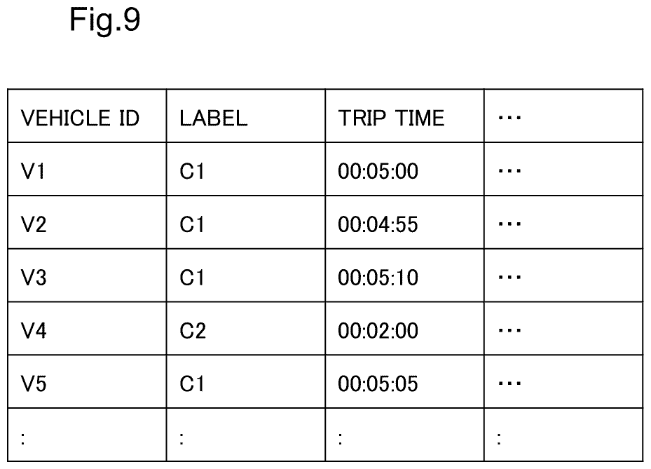

FIG. 9 illustrates contents recorded in the trip time recording means 104 when the emergency vehicle C2 sounds the siren and travels in In the example of FIG. 9, the trip time of the vehicle an emergency. group with the label C1 is increased, and the trip time of the vehicle with the label C2 is reduced. This indicates that the vehicle group with the label Cl stops in the left lane (right side in FIG. 8) in such a way as not to hinder the traveling by the emergency vehicle C2, while the emergency vehicle C2 travels at a high speed.

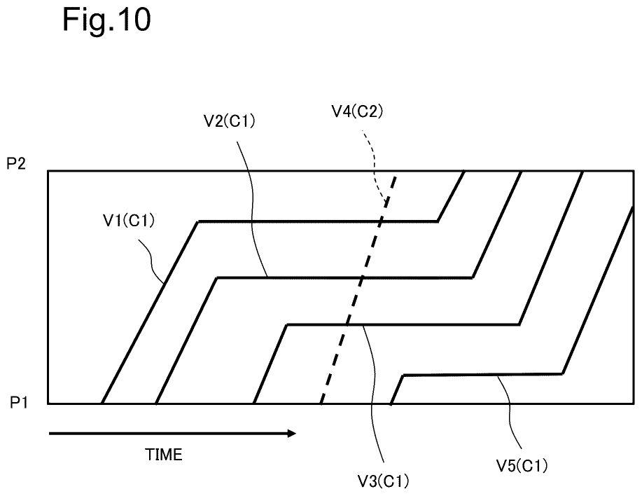

FIG. 10 is a diagram illustrating an example of a time distance diagram created from the data of FIG. 9 by the trip time measurement device 100 according to the present example embodiment. The location where a line indicating the movement of the vehicle with the label C1 in FIG. 10 is horizontal represents the position and time when each vehicle stopped. A location where a line indicating the movement of the vehicle with the label C1 and a line indicating the movement of the emergency vehicle with the label C2 cross each other indicates a location where the emergency vehicle overtook the vehicle with the label C1.

As described above, according to the trip time measurement device 100 of the present example embodiment, it is easy to grasp the movement of the vehicles to which the labels C1 and C2 are applied.

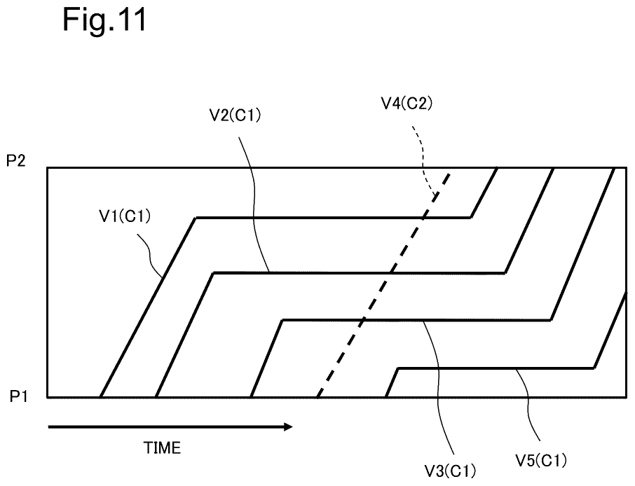

On the other hand, there is a case where the vehicle with the label C1 cannot give way to the emergency vehicle because the road width is narrow, the bus is stopped, there is a vehicle parked on the road, or the like. FIG. 11 is a diagram illustrating an example of a time distance diagram created by the trip time measurement device 100 in this case. In the example of FIG. 11, the inclination of the line indicating the movement of the emergency vehicle with the label C2 is smaller than that in FIG. 10. That is, it indicates that a situation that hinders the movement of the emergency vehicle, such as a situation that a safe interval with the stopping vehicle cannot be maintained, has occurred. Accompanied therewith, the stopping time of the vehicle with the label C1 also increases. By providing such a time distance diagram, the trip time measurement device 100 according to the present example embodiment can cause a road manager or the like to grasp, for example, an insufficient road width, a need for a bus evacuation area, or a problem of on-road parking. In addition, the trip time measurement device 100 creates an evaluation of a road situation such as a road width shortage, the necessity of a bus evacuation area, or a problem of on-road parking based on the analysis result as described above, and provides the evaluation to the traffic information provision server 200.

As described above, according to the trip time measurement device 100 of the present example embodiment, trip time for each attribute of various vehicles traveling on a road is measured, and various findings can be obtained from the analysis result.

In the above example, description has been made with the label C2 applied to the emergency vehicle, and the label C1 applied to the other vehicles, but the rule of applying the label is not limited thereto. For example, the label C1 can be applied to a small sized passenger vehicle, and the label C2 can be applied to a vehicle (e.g., a standard sized passenger vehicle) having a wider vehicle width than the vehicle.

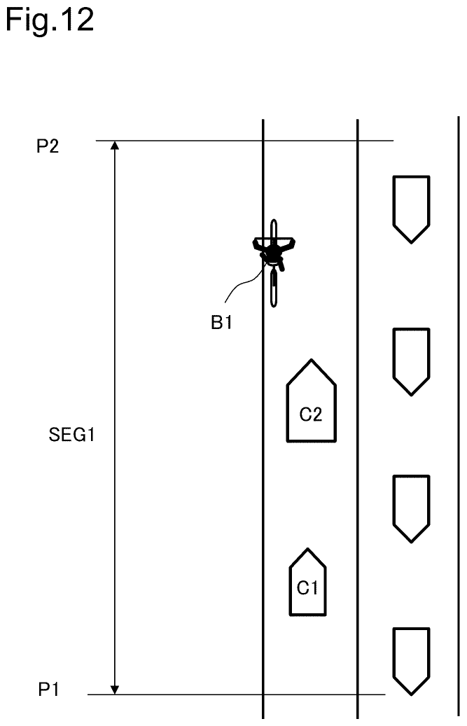

For example, as shown in FIG. 12, there is a case where a bicycle B1 is traveling on a road side with one lane on each side. At this time, in a relationship between a road width and a vehicle width of a vehicle, a small sized passenger vehicle can overtake while maintaining a distance from a bicycle, but a standard sized passenger vehicle having a larger vehicle width than the small sized passenger vehicle may have difficulty in overtaking the bicycle. According to the trip time measurement device 100 of the present example embodiment, the trip times of a small sized passenger vehicle and a standard sized passenger vehicle can be separately measured, and thus, it is possible to check whether the passage of a specific vehicle model is affected by the width of a road or the presence of a bicycle or the like.

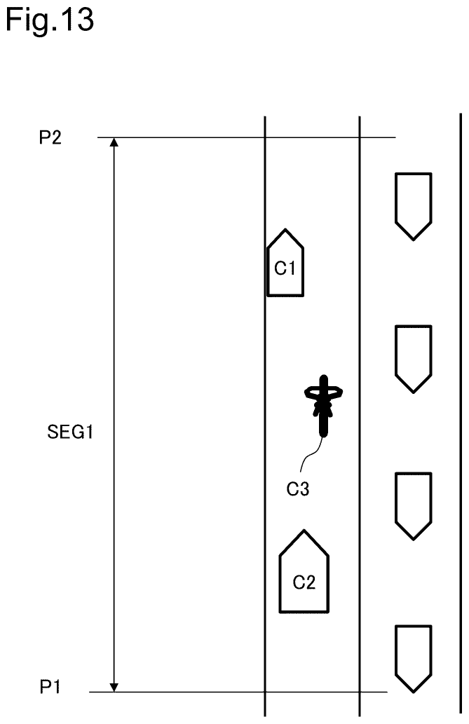

In addition to the above, it is also possible to apply a label C3 to a two-wheeled vehicle such as a motorcycle to serve as a target of trip time measurement. For example, as illustrated in FIG. 13, there is a case where a small sized passenger vehicle with a label C1, a two-wheeled vehicle with a label C3, and a standard sized passenger vehicle with a label C2 are traveling in this order on one lane on each side. At this time, there is a case where the two-wheeled vehicle passes by the right side of the small sized passenger vehicle with the label C1 to overtake the small sized passenger vehicle. On the other hand, it is difficult for the standard sized passenger vehicle with the label C2 to overtake the small sized passenger vehicle without running out to the right lane due to the width of the road. According to the trip time measurement device 100 of the present example embodiment, the trip time of each of the small sized passenger vehicle, the two-wheeled vehicle, and the standard sized passenger vehicle can be measured, and the trip time when the four-wheeled vehicle such as the small sized passenger vehicle or the standard sized passenger vehicle is used and the trip time when the two-wheeled vehicle is used can be individually grasped. By providing such trip time for each vehicle model by the traffic information provision server, the user can select an optimal route according to his/her transportation means and destination.

It is also preferable that trip time measurement device 100 applies a plurality of labels from different viewpoints to one vehicle. For example, a complex analysis of trip time can be performed by defining a plurality of labeling rules such as a vehicle category, a vehicle model, an application, a color and a symbol of a license plate, and whether the vehicle is a special vehicle, and performing labeling in combination. For example, by combining the above-described label indicating whether the vehicle is an emergency vehicle and the label indicating whether the vehicle is a four-wheeled vehicle or a two-wheeled vehicle, it is possible to compare a predicted time for when traveling by a four-wheeled vehicle and a predicted time for when traveling by a two-wheeled vehicle such as a police's white motorcycle when the police vehicle travels to the site in the emergency travel.

In the above example embodiment, the trip time measurement device 100 has been described as including the evaluation means 107, but the evaluation means 107 may be omitted. In this case, the user who has received the provision of data from the traffic information provision server 200 may evaluate the road instead of the evaluation means 107 with reference to the value of the trip time for each label and the time distance diagram.

### Second Example Embodiment

In the above-described example embodiment, it has been described that the traffic information provision server 200 provides the user terminal 300 with the trip time measured by the trip time measurement device 100, the time distance diagram, or the analysis results thereof, but the trip time can also be used for route calculation. Hereinafter, a second example embodiment in which the traffic information provision server 200 uses the trip time in route calculation for a vehicle will be described.

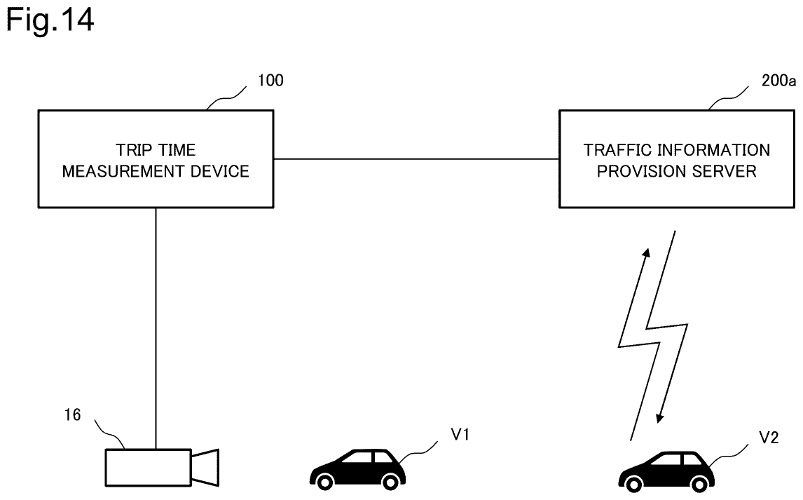

FIG. 14 is a diagram illustrating a configuration of a second example embodiment of the present invention. Referring to FIG. 14, there is illustrated a configuration in which a trip time measurement device 100 capable of acquiring an image from a camera 16 and a traffic information provision server 200a that responds to a route calculation request from a vehicle V2 are connected. Since the configuration and operation of the trip time measurement device 100 are similar to those of the first example embodiment, the description thereof will be omitted.

Upon receiving a route calculation request from an in-vehicle terminal mounted on the vehicle V2, the traffic information provision server 200a calculates a route using trip time information of a vehicle having an attribute approximate to that of the vehicle V2. Of course, the route may be calculated in the same manner as the general route calculation in the segment without the measurement data. When the calculation is completed, the traffic information provision server 200a transmits a result of the route calculation (route information) to the in-vehicle terminal mounted on the vehicle V2.

As described above, according to the present example embodiment, it is possible to provide a highly accurate route calculation service. The reason is that the traffic information provision server 200a is configured to calculate a route using a trip time measured by the trip time measurement device 100. In the example of FIG. 14, the traffic information provision server 200a performs the route calculation, but the route calculation may be performed on the in-vehicle terminal side. In this case, the trip time measurement device 100 or the traffic information provision server 200a may provide the trip time measured in a road section around the vehicle V2 to an in-vehicle terminal mounted on the vehicle V2. In this case, the in-vehicle terminal of the vehicle V2 calculates the shortest route by using the provided trip time as the weight information of the link for route calculation.

Although the example embodiments of the present invention have been described above, the present invention is not limited to the above-described example embodiments, and further modifications, substitutions, and adjustments can be made within a scope not deviating from the basic technical idea of the present invention. For example, the network configuration, the configuration of each element, and the representation form of data illustrated in the drawings are examples for assisting the understanding of the present invention, and are not limited to the configurations illustrated in the drawings.

For example, in the drawings of each of the example embodiments described above, the predetermined segment has been described as a straight segment, but the predetermined segment may not be a straight segment, and may be separated by several kilometers or more in terms of distance.

### (Regarding Hardware Configuration)

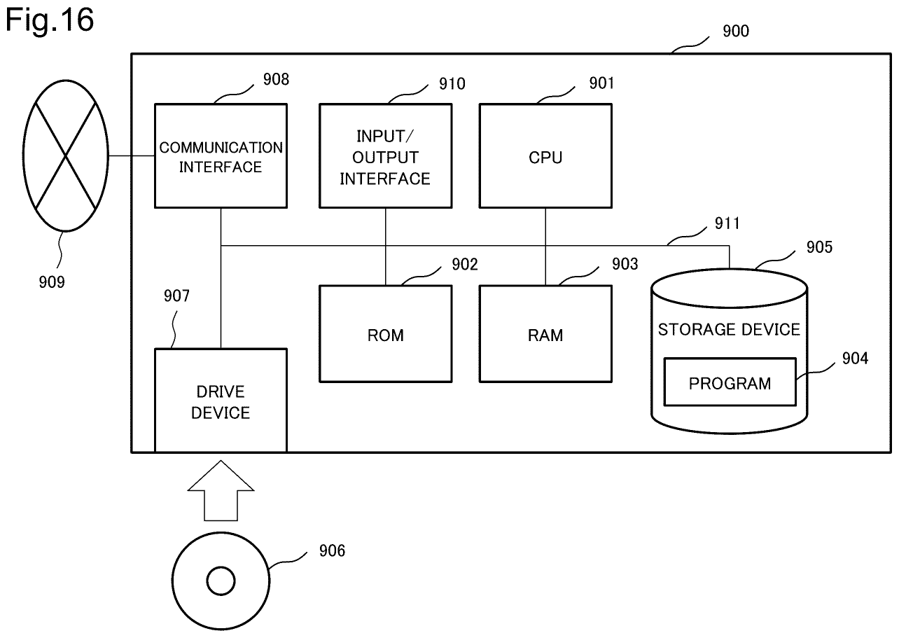

In each example embodiment of the present disclosure, each component of each device indicates a block of a functional unit. A part or all of each component of each device is achieved by, for example, an arbitrary combination of the information processing device 900 and a program as illustrated in FIG. 16. FIG. 16 is a block diagram illustrating an example of a hardware configuration of the information processing device 900 that is implemented as each component of each device. The information processing device 900 includes the following configuration as an example.
Central Processing Unit (CPU) 901
Read Only Memory (ROM) 902
Random Access Memory (RAM) 903
Program 904 loaded into RAM 903
Storage device 905 storing program 904
Drive device 907 for reading and writing program recording medium 906
Communication interface 908 connected to communication network 909
Input/output interface 910 for inputting/outputting data
Bus 911 connecting each component

Each component of each device in each example embodiment is achieved by the CPU 901 acquiring and executing the program 904 for implementing these functions. That is, the CPU 901 of FIG. 16 may execute a program for detecting a vehicle and identifying an attribute of the vehicle and a program for measuring trip time, and may perform update process of each calculation parameter held in a program recording medium such as the RAM 903 or the storage device 905. The program 904 for implementing the function of each component of each device is stored in the storage device 905 or the ROM 902 in advance, for example, and is read by the CPU 901 as necessary. The program 904 may be supplied to the CPU 901 via the communication network 909, or may be stored in advance in the program recording medium 906, and the drive device 907 may read the program and supply the program to the CPU 901.

The program 904 can display the processing result including the intermediate state for each stage via the display device as necessary, or can communicate with the outside via the communication interface. In addition, the program 904 can be recorded in a computer-readable (non-transitory) storage medium.

There are various modifications for the implementation method of each device. For example, each device may be achieved by an arbitrary combination of the information processing device 900 and the program separate for each component. Furthermore, a plurality of components included in each device may be achieved by an arbitrary combination of one information processing device 900 and a program. That is, the present invention can be achieved by a computer program that causes the communication terminal, the network control device, and the processor mounted in these devices described in the first to third example embodiments to execute each of the above-described processes using the hardware.

A part or all of each component of each device is achieved by other general-purpose or dedicated circuit, processor, or the like, or a combination thereof. These may be configured by a single chip or may be configured by a plurality of chips connected via a bus.

A part or all of each component of each device may be achieved by a combination of the above-described circuit or the like and a program.

In a case where a part or all of each component of each device is achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a form in which various modifications are made.

Some or all of the above example embodiments may be described as the following supplementary notes, but are not limited to the following.

### [Supplementary Note 1]

A trip time measurement device including:
a detection means for detecting vehicles traveling on a road from an image of the road captured by a camera;
a labeling means for identifying attributes of the detected vehicles and applying labels relevant to the attributes;
a first trip time measurement means for measuring a first trip time required for a vehicle having a first label, from among the identified vehicles, to travel a predetermined segment of the road;
a second trip time measurement means for measuring a second trip time required for a vehicle having a second label, from among the identified vehicles, to travel the predetermined segment; and
an output means for outputting each of the first trip time and the second trip time.

### [Supplementary Note2]

A configuration can be adopted in which the trip time measurement device described above further includes
an evaluation means for evaluating a situation of a road,
the labeling means applies the second label to a vehicle having a wider vehicle width than a vehicle applied with the first label, and
the evaluation means compares the first trip time with the second trip time to generate an evaluation on an appropriateness of the width of the road.

### [Supplementary Note 3]

A configuration can be adopted in which the labeling means of the trip time measurement device applies the first label to a small sized passenger vehicle and applies the second label to a standard sized passenger vehicle.

### [Supplementary Note 4]

A configuration can be adopted in which the trip time measurement device further includes
an evaluation means for evaluating a situation of a road,
the labeling means applies the second label to an emergency vehicle, and applies the first label to a vehicle other than the emergency vehicle, and
the evaluation means is configured to generate an evaluation as to whether the road is suitable for traveling by the emergency vehicle based on the first trip time and the second trip time.

### [Supplementary Note 5]

A configuration can be adopted in which the labeling means of the trip time measurement device applies the first label to a two-wheeled vehicle and applies the second label to a four-wheeled vehicle.

### [Supplementary Note 6]

In the trip time measurement device described above, a configuration can be adopted in which the predetermined segment is a segment set between a first position and a second position in a captured image of the camera.

### [Supplementary Note 7]

A configuration can be adopted in which the trip time measurement device described above further includes a providing means for providing the first trip time and the second trip time to a predetermined traffic information provision server.

### [Supplementary Note 8]

A configuration can be adopted in which the trip time measurement device described above includes a chart creating means for creating a time distance diagram representing a movement situation of the vehicle from the first position to the second position in time series.

### [Supplementary Note 9]

A traffic information provision server for receiving the first trip time and the second trip time from the trip time measurement device and providing the first trip time and the second trip time to a user terminal as traffic information.

### [Supplementary Note 10]

The traffic information provision server that,
receives the first trip time and the second trip time from the trip time measurement device;
performs route calculation using at least one of the first trip time and the second trip time in response to a request from a user terminal; and provides a result of the route calculation to the user terminal as route information.

### [Supplementary Note 11]

A trip time measurement method including:
detecting vehicles traveling on a road from an image of the road captured by a camera;
identifying attributes of the detected vehicles and applying labels relevant to the attributes;
measuring a first trip time required for a vehicle having a first label, from among the identified vehicles, to travel a predetermined segment of the road;
measuring a second trip time required for a vehicle having a second label, from among the identified vehicles, to travel the predetermined segment; and
outputting each of the first trip time and the second trip time.

### [Supplementary Note 12]

A program recording medium recorded with a program for causing a computer to execute processes of:
detecting vehicles traveling on a road from an image of the road captured by a camera;

identifying attributes of the detected vehicles and applying labels relevant to the attributes;
measuring a first trip time required for a vehicle having a first label, from among the identified vehicles, to travel a predetermined segment of the road;
measuring a second trip time required for a vehicle having a second label, from among the identified vehicles, to travel the predetermined segment; and
outputting each of the first trip time and the second trip time.

The forms of the supplementary notes 11 to 12 can be developed to the forms of the supplementary notes 2 to 8, similarly to the supplementary note 1.

The disclosures of the above patent literatures are incorporated herein by reference, and can be used as a basis or part of the present invention as necessary. Within the frame of the entire disclosure (including claims) of the present invention, it is possible to change and adjust the example embodiments or examples further based on the basic technical idea. In addition, various combinations or selections (including partial deletions) of various disclosed elements (including each element of each claim, each element of each example embodiment or example, each element of each drawing, and the like) can be made within the frame of the disclosure of the present invention. That is, it is a matter of course that the present invention includes various modifications and corrections that can be contrived by those skilled in the art in accordance with the entire disclosure including the claims and the technical idea. In particular, for numerical ranges set forth herein, any numerical value or sub-range included within the range should be construed as being specifically described, even if not stated otherwise. Furthermore, it is also deemed that the matters disclosed in the documents cited above are included in the matters disclosed in the present application to use a part or all of the matters disclosed in the documents in combination with the matters described in the present specification as part of the disclosure of the present invention according to the gist of the present invention as necessary.

### REFERENCE SIGNS LIST

10, 100 trip time measurement device
11, 101 detection means
12, 102 labeling means
13 first trip time measurement means
14 second trip time measurement means
15 output means
16 camera
103 trip time measurement means
104 trip time recording means
105 providing means
106 chart creating means
107 evaluation means
200, 200a traffic information provision server
300 user terminal
900 information processing device
901 central processing unit (CPU)
902 read only memory (ROM)
903 random access memory (RAM)
904 program
905 storage device
906 program recording medium
907 drive device
908 communication interface
909 communication network
910 input/output interface
911 bus
V1, V2 vehicle

What is claimed is:

1. A measurement device comprising:
at least one memory configured to store instructions: and
at least one processor configured to execute the instructions to:
detect one or more vehicles traveling on a road based on an image of the road captured by a camera;
identify attributes of the detected vehicles;
apply one or more labels to the one or more vehicles relevant to the attributes;
measure a first trip time required for a vehicle of the one or more vehicles having a first label of the one or more labels, to travel along a segment of the road;
measure a second trip time required for a vehicle of the one or more vehicles having a second label, to travel along the predetermined segment of the road; and
output each of the first trip time and the second trip time.

2. The measurement device according to claim 1,
wherein the at least one processor is further configured to execute the instructions to:
apply the second label to a vehicle of the one or more vehicles having a width wider than a vehicle of the one or more vehicles applied with the first label; and,
compare the first trip time with the second trip time; and
generate an evaluation on an appropriateness of the width of the road based on the comparison.

3. The measurement device according to claim 1,
wherein the at least one processor is further configured to execute the instructions to:
apply the first label to a small sized passenger vehicle of the one or more vehicles and apply the second label to a standard sized passenger vehicle of the one or more vehicles.

4. The measurement device according to claim 1,
wherein the at least one processor is further configured to execute the instructions to:
apply the second label to an emergency vehicle of the one or more vehicles;
apply the first label to a vehicle of the one or more vehicles other than the emergency vehicle; and
generate an evaluation as to whether the road is suitable for the emergency vehicle based on the first trip time and the second trip time.

5. The measurement device according to claim 1,
wherein the at least one processor is further configured to execute the instructions to:
apply the first label to a two-wheeled vehicle of the one or more vehicles and applies the second label to a four-wheeled vehicle of the one or more vehicles.

6. The measurement device according to claim 1, wherein the segment is set between a first position and a second position in the image captured by of the camera.

7. The measurement device according to claim 1,
wherein the at least one processor is further configured to execute the instructions to:
provide the first trip time and the second trip time to a traffic information provision server.

8. The trip time measurement device according to claim 1,
wherein the at least one processor is further configured to execute the instructions to:
create a time distance diagram representing a movement of a vehicle of the one or more vehicles from a first position to a second position in time series.

9-10. (canceled)

11. A measurement method comprising:
detecting one or more vehicles traveling on a road based on an image of the road captured by a camera;
identifying attributes of the detected vehicles;
apply one or more labels to the one or more vehicles relevant to the attributes;
measuring a first trip time required for a vehicle of the one or more vehicles having a first label of the one or more labels, to travel along a segment of the road;
measuring a second trip time required for a vehicle of the one or more vehicles having a second label, to travel along the of the road; and
outputting each of the first trip time and the second trip time.

12. A program recording medium non-transitorily recording a program recorded thereon for causing a computer to execute processes of:
detecting one or more vehicles traveling on a road based on an image of the road captured by a camera;
identifying attributes of the detected vehicles;
apply one or more labels to the one or more vehicles relevant to the attributes;
measuring a first trip time required for a vehicle of the one or more vehicles having a first label of the one or more labels, to travel along a segment of the road;
measuring a second trip time required for a vehicle of the one or more vehicles having a second label, to travel along the segment of the road; and
outputting each of the first trip time and the second trip time.

13. A measurement method according to claim 11 comprising:
applying the second label to a vehicle of the one or more vehicles having a width wider than a vehicle of the one or more vehicles applied with the first label;
comparing the first trip time with the second trip time; and
generating an evaluation on an appropriateness of the width of the road based on the comparison.

14. A measurement method according to claim 11 comprising:
applying the first label to a small sized passenger vehicle of the one or more vehicles and apply the second label to a standard sized passenger vehicle of the one or more vehicles.

15. A measurement method according to claim 11 comprising:
applying the second label to an emergency vehicle of the one or more vehicles;
apply the first label to a vehicle of the one or more vehicles other than the emergency vehicle; and
generating an evaluation as to whether the road is suitable for the emergency vehicle based on the first trip time and the second trip time.

16. A measurement method according to claim 11 comprising:
applying the first label to a two-wheeled vehicle of the one or more vehicles and applies the second label to a four-wheeled vehicle of the one or more vehicles.

17. A program recording medium according to claim 12 non-transitorily recording a program recorded thereon for causing a computer to execute processes of:
apply the second label to a vehicle of the one or more vehicles having a width wider than a vehicle of the one or more vehicles applied with the first label;
comparing the first trip time with the second trip time; and
generating an evaluation on an appropriateness of the width of the road based on the comparison.

18. A program recording medium according to claim 12 non-transitorily recording a program recorded thereon for causing a computer to execute processes of:
apply the first label to a small sized passenger vehicle of the one or more vehicles and apply the second label to a standard sized passenger vehicle of the one or more vehicles.

19. A program recording medium according to claim 12 non-transitorily recording a program recorded thereon for causing a computer to execute processes of:
apply the second label to an emergency vehicle of the one or more vehicles;
apply the first label to a vehicle of the one or more vehicles other than the emergency vehicle; and
generating an evaluation as to whether the road is suitable for the emergency vehicle based on the first trip time and the second trip time.

20. A program recording medium according to claim 12 non-transitorily recording a program recorded thereon for causing a computer to execute processes of:
apply the first label to a two-wheeled vehicle of the one or more vehicles and applies the second label to a four-wheeled vehicle of the one or more vehicles.
